(19) United States
(12) Patent Application Publication
(10) Pub. No.: US 2007/0008058 A1
(43) Pub. Date: Jan. 11, 2007

(54) Manufacturing method for electronic substrate, electronic substrate, and electronic apparatus

(75) Inventor: Nobuaki Hashimoto, Suwa (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/478,013

(22) Filed: Jun. 29, 2006

(30) Foreign Application Priority Data
Jul. 5, 2005 (JP) 2005-196094

(51) Int. Cl. H01F 5/00

(52) U.S. Cl. 336/200

(57) ABSTRACT

A manufacturing method for an electronic substrate, includes: preparing a substrate having an electronic circuit including connection terminals; forming a core on the substrate and forming a helical conductive member on the core, thereby forming an inductor including the ring-shaped core and the helical conductive member; and using at least a portion of the helical conductive member as a relocated wiring and connecting the relocated wiring to the connection terminals of the electronic circuit.

### CROSS-REFERENCE TO RELATED APPLICATION

This application claims priority from Japanese Patent Application No. 2005-196094, filed Jul. 5, 2005, the contents of which are incorporated herein by reference.

### BACKGROUND

1. Technical Field

The present invention relates to a manufacturing method for an electronic substrate, an electronic substrate, and electronic apparatus.

2. Related Art

Semiconductor chips (electronic substrates) on which electronic circuits are formed are packaged in portable telephones, personal computers, and other electronic apparatus.

Such semiconductor chips may also be used together with resistors, inductors, capacitors, and other passive elements.

As disclosed in Japanese Unexamined Patent Application, First Publication No. 2002-164468 and in Japanese Unexamined Patent Application, First Publication No. 2003-347410, techniques have been proposed for forming spiral inductors on semiconductor chips.

A spiral inductor is formed with wire-wound in a spiral shape on the active surface.

However, due to interference of the silicon in the semiconductor chip with the magnetic flux of a spiral inductor, leakage currents occur, and so there are limits to improvement of the Q value (the ratio of the inductance to the resistance value).

In order to resolve this problem, a technique has been proposed for forming a toroidal inductor on a semiconductor chip, as disclosed in Ermolov et al, “Microreplicated RF Toroidal Inductor”, IEEE Transactions on Microwave Theory and Techniques, Vol. 52, No. 1, Jan. 2004, p. 29-36.

A toroidal inductor is formed with wire-wound in a helical shape about a ring-shaped core placed parallel to the active surface.

However, in this technology, MEMS (Micro-Electro-Mechanical Systems) techniques and transfer techniques are used to form the toroidal inductor, so that there is the problem in that special processes using dies and similar are required.

### SUMMARY

An advantage of some aspects of the invention is to provide a manufacturing method for an electronic substrate and an electronic substrate, which enables simple manufacturing for an inductor and ensuring a high Q value.

Another advantage of aspect of the invention is to provide an electronic apparatus with superior electrical characteristics at low cost.

A first aspect of the invention provides a manufacturing method for an electronic substrate, including: preparing a substrate having an electronic circuit including connection terminals; forming a core on the substrate and forming a helical conductive member on the core, thereby forming an inductor including the ring-shaped core and the helical conductive member; and using at least a portion of the helical conductive member as a relocated wiring and connecting the relocated wiring to the connection terminals of the electronic circuit.

It is preferable that, in the manufacturing method for an electronic substrate of the first aspect of the invention, the forming of the core include forming a stress-relieving layer on the substrate.

It is preferable that, in the manufacturing method for an electronic substrate of the first aspect of the invention, the forming of the inductor include: forming first conductive elements constituting at least a potion of the helical conductive member on the substrate; forming a stress-relieving layer so as to cover the first conductive elements; forming the core by forming penetrating holes in the stress-relieving layer so as to expose end portions of the first conductive elements; and forming second conductive elements constituting at least a portion of the helical conductive member, and extending from the end portions of the first conductive elements to a surface of the core via the penetrating holes.

By means of this configuration, the inductor can be formed simply and at low cost without entailing an extreme increase in the number of processes, and without requiring dies or other special facilities.

It is preferable that the manufacturing method for an electronic substrate of the first aspect of the invention, further include: removing at least a portion of the core placed inside the helical conductive member.

By means of this configuration, disordering of magnetic flux lines in the core can be reduced, the magnetic permeability can be improved, and the inductance and Q value can be improved.

It is preferable that the manufacturing method for an electronic substrate of the first aspect of the invention, further include: forming a high magnetic permeability member having a magnetic permeability higher than that of the stress-relieving layer in at least a portion of the core placed inside the helical conductive member.

By means of this configuration, the magnetic flux density in the core can be improved, and the inductor Q value can be improved.

It is preferable that the manufacturing method for an electronic substrate of the first aspect of the invention, further include: trimming a portion of the helical conductive member, thereby adjusting characteristics of the inductor.

By means of this configuration, an inductor having desired characteristics can be formed.

A second aspect of the invention provides an electronic substrate manufactured by the above-described manufacturing method for an electronic substrate.

By means of this configuration, an electronic substrate on which an inductor with a high Q value is formed can be provided at low cost.

A third aspect of the invention provides an electronic substrate, including: a substrate provided with an electronic circuit including connection terminals; an inductor including a ring-shaped core formed on the substrate and a helical conductive member formed outside the core; and a relocated wiring constituting at least a portion of the helical conductive member, made of the same material as that of the helical conductive member, and connected to the connection terminals of the electronic circuit.

It is preferable that the electronic substrate of the third aspect of the invention, further include: a stress-relieving layer made of the same material as that of the core, and formed on the substrate.

It is preferable that the electronic substrate of the third aspect of the invention, further include: a stress-relieving layer formed on the substrate, including the core, covering at least a portion of the helical conductive member, having penetrating holes formed in the stress-relieving layer, and exposing end portions of at least a portion of the helical conductive member formed outside the core. The inductor includes: first conductive elements constituting at least a potion of the helical conductive member, and formed on the substrate; and second conductive elements constituting at least a potion of the helical conductive member, and extending from the end portions of the first conductive elements to a surface of the core via the penetrating holes.

By means of this configuration, an inductor can be formed simply and at low cost without entailing an extreme increase in the number of processes, and without requiring dies or other special facilities.

It is preferable that, in the electronic substrate of the third aspect of the invention, the spaces between the first conductive elements or the spaces between the second conductive elements are formed with substantially a constant width.

By means of this configuration, the L/S (Line and Space) ratio of the helical conductive member is made large, and wiring resistance can be reduced.

It is preferable that, in the electronic substrate of the third aspect of the invention, a space be formed inside at least a portion of the helical conductive member.

By means of this configuration, disordering of magnetic flux lines in the core can be reduced, the magnetic permeability can be improved, and the inductance Q value can be improved.

It is preferable that, in the electronic substrate of the third aspect of the invention, the core include amorphous metal or metallic glass.

By means of this configuration, the magnetic flux density in the core can be improved, and the inductor Q value can be improved.

It is preferable that the electronic substrate of the third aspect of the invention, further include: a conductive layer formed between the electronic circuit and the inductor.

By means of this configuration, the effect exerted by the magnetic field of the inductor on the electronic circuit (coupling) can be reduced through an electromagnetic shielding effect.

A fourth aspect of the invention provides an electronic apparatus including the above-described electronic substrate.

By means of this configuration, an electronic substrate on which the inductor with a high Q value is formed at low cost is obtained, so that electronic apparatus having superior electrical characteristics can be provided at low cost.

### BRIEF DESCRIPTION OF THE DRAWINGS

FIG. 1A is a plan view of a semiconductor chip which explains a relocated wiring, and FIG. 1B is a cross-sectional view taken along the line B-B in FIG. 1A, which explains the relocated wiring.

FIG. 2A is a plan view of the semiconductor chip of a first embodiment, FIG. 2B is a cross-sectional view of the semiconductor chip taken along the line C-C in FIG. 2A;

FIG. 3 is a plan view of the semiconductor chip of a first modified example of the first embodiment.

FIG. 4 is a cross-sectional view of the semiconductor chip of a second modified example of the first embodiment;

FIGS. 5A to 5E are cross-sectional views that explain a manufacturing method for the semiconductor chip of the first embodiment.

FIGS. 6A and 6B are cross-sectional views that explain a manufacturing method for the semiconductor chip of the first embodiment.

FIG. 7A is a plan view of the semiconductor chip of a second embodiment, FIG. 7B is a cross-sectional view of the semiconductor chip taken along the line D-D in FIG. 7A.

FIG. 8 is a cross-sectional view of the semiconductor chip of a modified example of the second embodiment.

FIG. 9 is a perspective view of a portable telephone set.

### DESCRIPTION OF EXEMPLARY EMBODIMENTS

Below, embodiments of the invention are explained, referring to the drawings.

The scale of the members in the drawings used in explanations have been modified as appropriate to sizes enabling recognition of the members.

### First Embodiment

In the semiconductor chip (electronic substrate) of a first embodiment, a process for forming a relocated wiring and a process for forming a stress-relieving layer are utilized to form a toroidal inductor.

First, the relocated wiring of connection terminals and the stress-relieving layer are explained.

Below, a toroidal inductor formed on a semiconductor chip (in particular on the active element formation surface side) is explained as an example of an electronic substrate.

As the electronic substrate, the opposite side of the active element formation surface of a semiconductor chip, or a silicon substrate, glass substrate, quartz substrate, crystallized quartz substrate, or other substrate on which no semiconductor elements are formed, but which is at least a substrate having an insulating surface, may be used.

Relocated Wiring

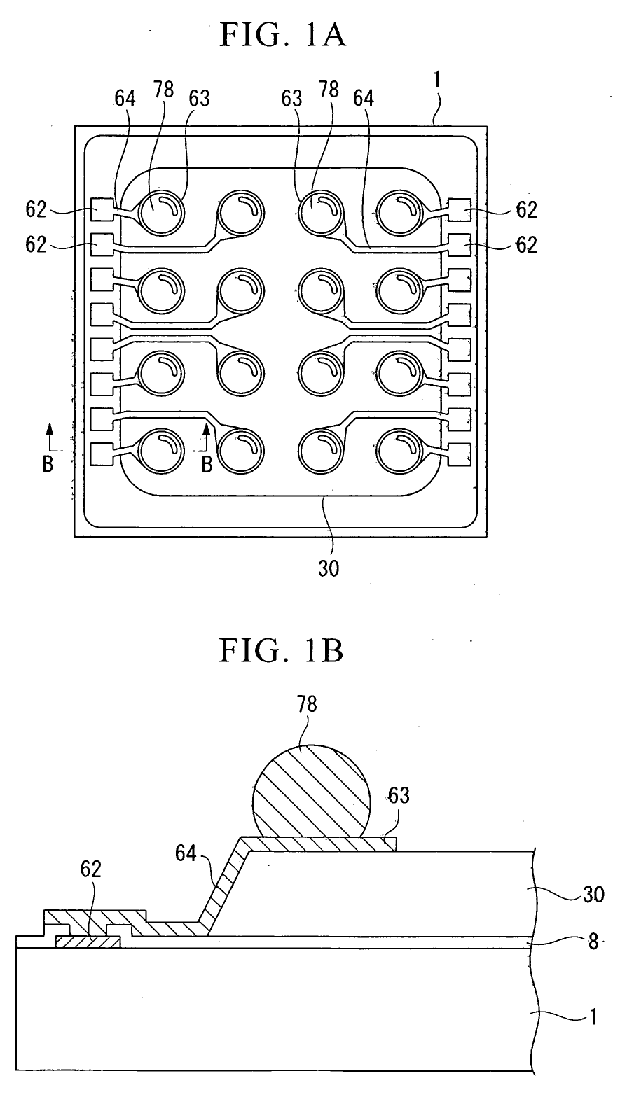

FIG. 1A is a plan view of a semiconductor chip which explains a relocated wiring.

FIG. 1B is a cross-sectional view taken along the line B-B in FIG. 1A, which explains the relocated wiring.

As shown in FIG. 1B, a passivation film 8 protecting an electronic circuit is formed on the surface of the semiconductor chip 1 on which the electronic circuit is formed.

Connection terminals 62 for electrical connection of the electronic circuit to external equipment are formed on the surface of the semiconductor chip 1.

Aperture portions in the passivation film 8 are formed on the surface of the connection terminals 62.

As shown in FIG. 1A, a plurality of connection terminals 62 are arranged along the peripheral portions of the semiconductor chip 1.

Due to the smaller sizes of semiconductor chips 1 in recent years, the pitch between adjacent connection terminals 62 has become extremely narrow.

When such a semiconductor chip 1 is packaged on a facing substrate facing to the semiconductor chip 1, there is the danger of short-circuitting across adjacent connection terminals 62.

Hence, in order to broaden the pitch between connection terminals 62, a relocated wiring 64 for the connection terminals 62 is formed.

Specifically, a plurality of pads 63 are arranged in a matrix (arrayed arrangement) in the center portion on the surface of the semiconductor chip 1.

The relocated wirings 64 drawn out from the connection terminals 62 are connected to these pads 63.

By this means, the narrow-pitch connection terminals 62 are drawn out into the center portion with a broader pitch.

In the forming of such a semiconductor chip 1, W-CSP (Wafer-level Chip Scale Package) technology is employed, in which relocated wiring and resin sealing are performed at once in the wafer state before separation into individual semiconductor chips 1.

When using this W-CSP technology to form semiconductor chips 1, it is necessary to ensure relieving stresses arising from differences between thermal expansion coefficients of the semiconductor chip 1 and the other substrate on which the semiconductor chip 1 is packaged.

Hence, as shown in FIG. 1B, a stress-relieving layer 30, containing a photosensitive polyimide and BCB (benzo-cyclobutene), a phenolic novolac resin, or another photosensitive resin, is formed in the center portion on the surface of the semiconductor chip 1.

Then, the pads 63 described above are formed on the surface of the stress-relieving layer 30.

Bumps 78 are formed on the surfaces of the pads 63.

These bumps 78 are for example solder bumps, and are formed by printing method or the similar methods.

These bumps 78 are packaged onto connection terminals on the facing substrate by reflow, FCB (Flip-Chip Bonding), or similar methods.

The pads 63 of the semiconductor chip 1 can also be packaged onto the connection terminals of the facing substrate via an anisotropic conductive film or the like.

Electronic Substrate Having a Toroidal Inductor

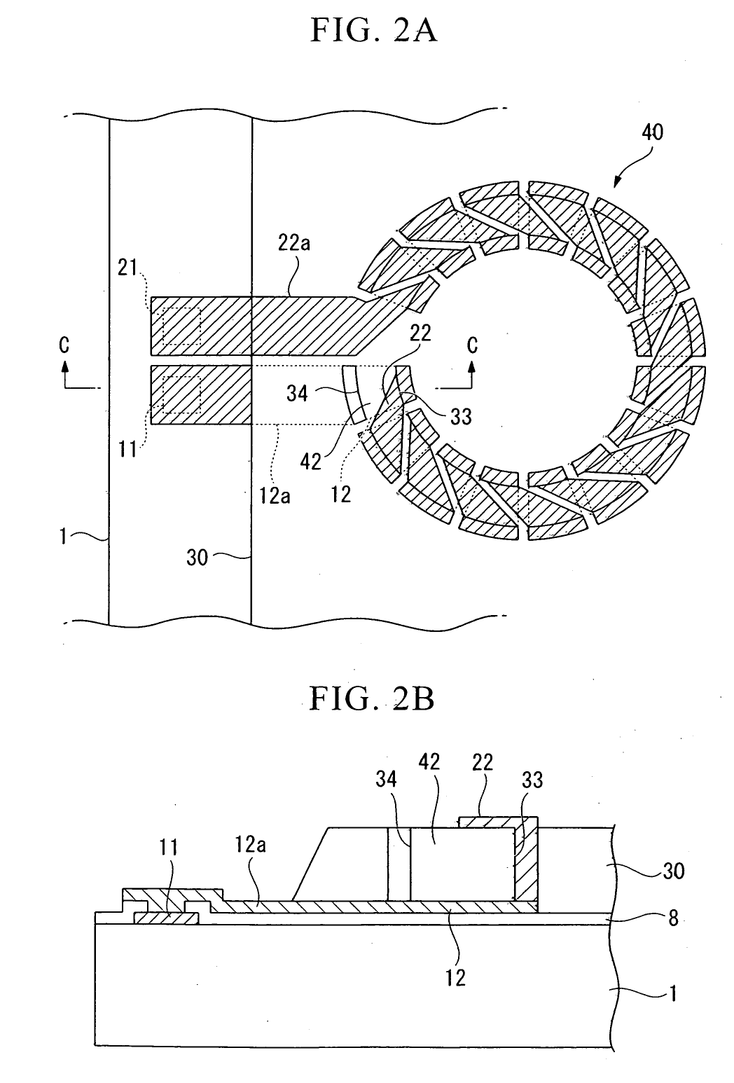

FIG. 2A is a plan view of the semiconductor chip of the first embodiment, and FIG. 2B is a cross-sectional view of the semiconductor chip taken along the line C-C in FIG. 2A.

On the semiconductor chip (electronic substrate) 1 of the first embodiment, a ring-shaped core 42 is formed by the stress-relieving layer 30, and a toroidal inductor 40 is formed from the helical conductive member of first conductive elements 12 and second conductive elements 22 placed on both surfaces of the stress-relieving layer 30.

As shown in FIG. 2B, the first conductive elements 12 is formed on the surface of the passivation film 8.

This first conductive elements 12 is formed from a conductive material such as copper (Cu), gold (Au), silver (Ag), titanium (Ti), tungsten (W), titanium tungsten (TiW), titanium nitride (TiN), nickel (Ni), nickel vanadium (NiV), chromium (Cr), aluminum (Al), palladium (Pd), or the like.

The constituent material of the first conductive elements 12 can be selected as appropriate according to the resistance range, current tolerance and other characteristics required of the helical conductive member of a toroidal inductor.

When forming the first conductive elements 12 by the electro plating method described below, the first conductive elements 12 is formed on the surface of a base layer (not shown in FIG. 2B).

As shown in FIG. 2A, the first conductive elements 12 are patterned into substantially a trapezoidal shape, and a plurality of first conductive elements 12 is arranged in a radial shape in a circle.

It is preferable that the spaces between adjacent first conductive elements 12 be formed at a constant width close to the resolution limits of photolithography.

By this means, the L/S (Line and Space) ratio of the first conductive elements 12 is made large, and the wiring resistance can be reduced.

One of the first conductive elements 12 is then connected to a connection terminal 11 via a connecting wiring 12a.

As shown in FIG. 2B, the stress-relieving layer 30 is formed so as to cover the first conductive elements 12.

Inner-side penetrating holes (vias) 33 and outer-side penetrating holes 34 are formed in this stress-relieving layer 30.

As shown in FIG. 2A, the inner-side penetrating holes 33 are formed so as to expose the inner-side end portions of the first conductive elements 12. The plurality of inner-side penetrating holes 33 are arranged in a circle.

The outer-side penetrating holes 34 are formed so as to expose the outer-side end portions of the first conductive elements 12. The plurality of outer-side penetrating holes 34 are arranged in a circle.

The shapes of the openings of the inner-side penetrating holes 33 and outer-side penetrating holes 34 may be fan-shaped, rectangular, oblong, elliptical, or the like.

Furthermore, in the plurality of inner-side penetrating holes 33 and/or the plurality of outer-side penetrating holes 34, each of adjacent penetrating holes may be connected, and circle-shaped groove may be formed.

As shown in FIG. 2B, the second conductive elements 22 is formed on the surface of the stress-relieving layer 30.

This second conductive elements 22 is also formed from conductive material similar to that of the first conductive elements 12.

The inner-side penetrating holes 33 and the outer-side penetrating holes 34 are also filled with the second conductive elements 22. The second conductive elements 22 is connected to the first conductive elements 12.

As shown in FIG. 2A, the second conductive elements element 22 is patterned so as to connect the inner-side penetrating hole 33 in the stress-relieving layer 30 formed over one first conductive elements element 12, and the outer-side penetrating hole 34 in the stress-relieving layer 30 formed over another first conductive elements element 12.

Similarly to the first conductive elements 12, it is preferable that the spaces between adjacent second conductive elements 22 be formed with constant widths close to the resolution limit of photolithography.

One second conductive elements element 22 is then connected to a connecting terminal 21 via a connecting wiring 22a.

In this way, the first conductive elements 12 and second conductive elements 22 are connected in succession, so that helical conductive member are formed.

A ring-shaped core 42 is formed by the stress-relieving layer 30 on the inside of the helical conductive member.

A toroidal inductor 40 is formed by the helical conductive member and the core 42.

An amorphous metal, metallic glass, or other material with high magnetic permeability (high magnetic permeability member) may be dispersed within the resin material of the stress-relieving layer 30 constituting the core 42.

By constituting the core 42 from this stress-relieving layer 30, the magnetic flux density can be increased, and the L value (inductance) and Q value of the toroidal inductor 40 can be improved.

A sputtering process, plating process, or other process may for example be used to provide the material forming the core 42 of high-permeability material (high magnetic permeability member), such as of permalloy alloy, amorphous metal, metallic glass, or the like, and this may be used as the core 42 of the toroidal inductor 40.

By this means, the L value (inductance) and Q value of the toroidal inductor 40 can be markedly improved.

The toroidal inductor 40 shown in FIG. 2A is connected to the connection terminals 11 and 21 of the electronic circuit of the semiconductor chip, to form a portion of the electronic circuit.

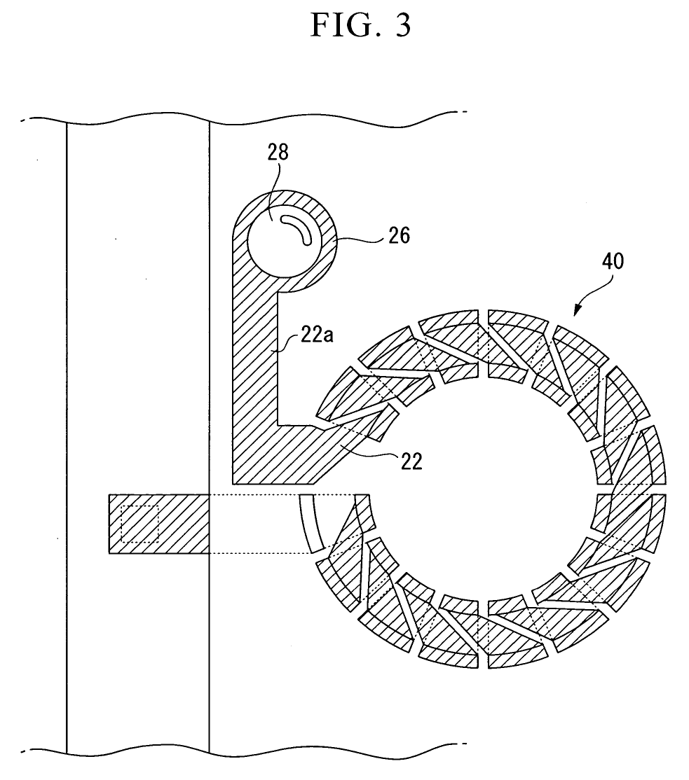

FIG. 3 is a plan view of a first modified example of the first embodiment.

In this first modified example, one of the second conductive elements 22 is connected to a pad 26 via a connecting wiring 22a.

A bump 28 is formed on the surface of this pad 26, enabling packaging on a facing substrate.

Hence, by means of this first modified example, a toroidal inductor 40 can be placed between the electronic circuit of the semiconductor chip and the facing substrate.

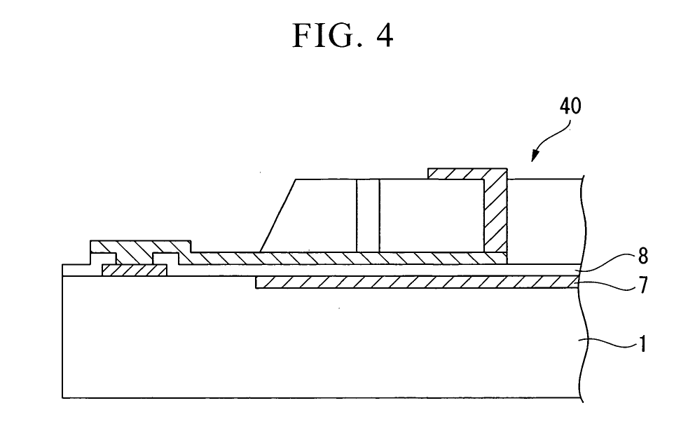

FIG. 4 is a cross-sectional view of a second modified example of the first embodiment.

In this second modified example, a conductive layer (shield layer) 7 is formed over substantially the entire surface on the rear side of the passivation film 8.

This conductive layer 7 can be formed by Al or the like using an electronic circuit formation process.

If the conductive layer 7 is grounded or held at a fixed potential, the effect of the magnetic field of the toroidal inductor 40 (coupling) on the electronic circuit, having active elements, of the semiconductor chip 1 can be reduced through an electromagnetic shielding effect.

The conductive layer 7 may be formed in any position between the toroidal inductor 40 and the electronic circuit.

Furthermore, even when not formed over substantially the entire surface of the semiconductor chip, the conductive layer 7 may be formed in at least the area of formation of the toroidal inductor 40.

Moreover, other passive components (inductors, capacitors, and resistors) may be integrated, either in the same plane as the toroidal inductor formation layer, or with a further insulating layer, dielectric layer and conductive layer provided above or below the toroidal inductor formation layer.

By this means, the component integration level can be further improved.

Manufacturing Method for Electronic Substrate

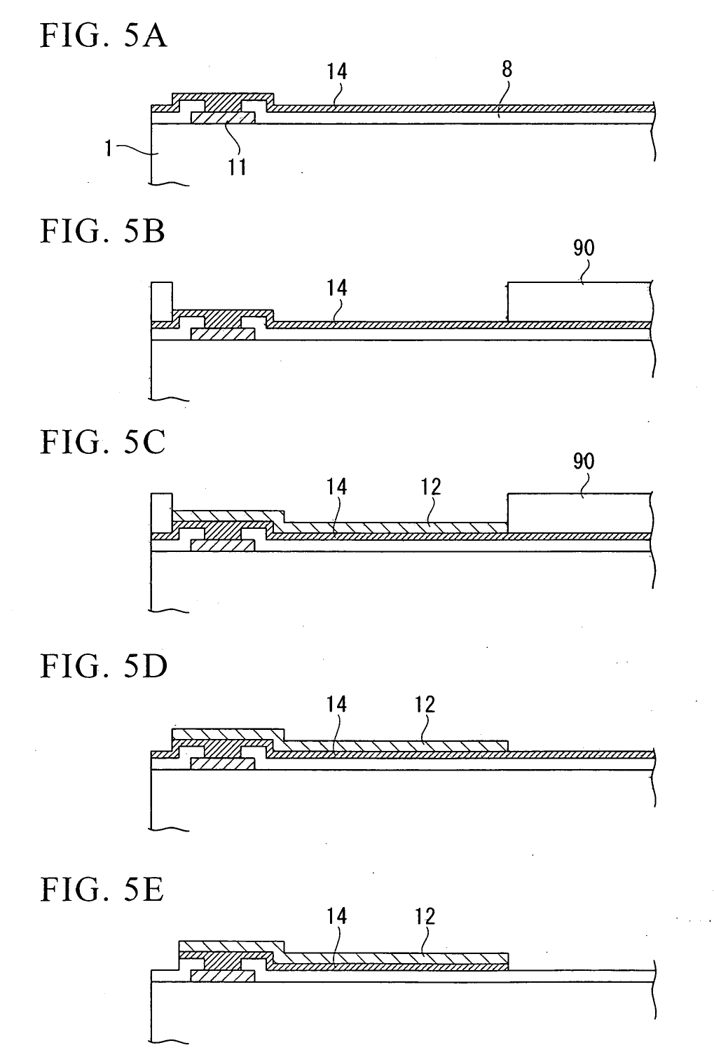

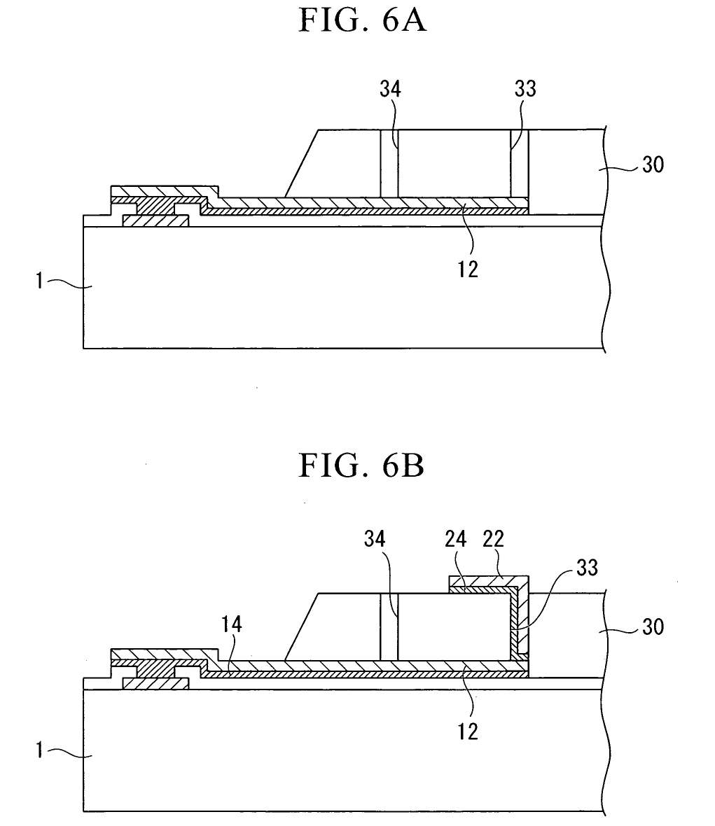

Next, a manufacturing method for the above-described semiconductor chip is explained using FIG. 5A through FIG. 6B.

FIGS. 5A to 5E are cross-sectional views that explain a manufacturing method for the semiconductor chip of the first embodiment.

Here, the explanation begins from a state in which, as shown in FIG. 5A, a passivation film 8 protecting the electronic circuit, and connection terminals 11 for electrical connection of an electronic circuit to external equipment, have been formed on the surface of a semiconductor chip on which the electronic circuit is formed, and openings are formed in the passivation film 8 on the surface of the connection terminals 11.

First, as shown in FIG. 5A, a base film 14 is formed over the entire surface of the semiconductor chip 1.

This base film 14 contains a lower barrier layer and an upper seed layer.

The seed layer functions as an electrode when using an electro plating method to form the first conductive elements, and is formed from Cu or the like to a thickness of approximately 100 nm.

The barrier layer prevents diffusion of Cu into the connection terminals, of Al or the like, and is formed from TiW, TiN or the like to a thickness of approximately 100 nm.

Each of these layers can be formed by vacuum deposition, sputtering, ion plating or other PVD (Physical Vapor Deposition) methods, or by IMP (Ion Metal Plasma) methods.

Next, as shown in FIG. 5B, a resist 90 is applied to the surface of the base film 14, photolithography is performed, and openings are formed in the resist 90 in the area for formation of the first conductive elements and connecting wirings (hereafter called “first conductive elements and similar”).

Next, as shown in FIG. 5C, electro Cu plating is performed, using the seed layer of the base film 14 as an electrode, to fill the openings in the resist 90 with Cu and form the first conductive elements 12 and similar.

Next, as shown in FIG. 5D, the resist is removed.

Next, as shown in FIG. 5E, the first conductive elements 12 and similar is used as a mask to etch the base film 14.

In this etching, reactive ion etching (RIE) or similar methods can be used.

Both the first conductive elements 12 and similar and the seed layer of the base film 14 are formed of Cu, but the first conductive elements 12 and similar is substantially thicker than the seed layer of the base film 14, so that the seed layer can be completely removed by etching.

Next, as shown in FIG. 6A, a stress-relieving layer 30 is formed so as to cover the first conductive elements 12.

The stress-relieving layer 30 is formed in the center portion on the surface of the semiconductor chip 1 using a printing method and photolithography.

The above-described inner-side penetrating holes 33 and outer-side penetrating holes 34 are formed in this stress-relieving layer 30.

As the dielectric material forming the stress-relieving layer, by choosing a resin material having photosensitive properties, photolithography can be used to simply and accurately pattern the stress-relieving layer 30.

Next, as shown in FIG. 6B, the second conductive elements 22 and a base layer 24 for same are formed to extend from the surface of the stress-relieving layer 30 to the interiors of the inner-side penetrating holes 33 and outer-side penetrating holes 34.

The specific method used is similar to the above-described methods of formation of the first conductive elements 12 and base film 14 thereof.

By using laser light or the like to trim the second conductive elements 22 formed on the surface of the stress-relieving layer 30, the inductance characteristics can be tuned.

The above-described second conductive elements 22 can be formed simultaneously with the relocated wiring 64 in the process of formation of the relocated wiring 64 shown in FIG. 1B.

That is, the second conductive elements 22 which is to become the helical conductive member of the toroidal inductor can be formed accurately using plating, photolithography, or similar methods.

Hence, a toroidal inductor having desired characteristics can be formed.

As explained in detail above, a toroidal inductor is formed on the semiconductor chip of this embodiment by forming a core 42 from a stress-relieving layer 30, and forming the helical conductive member simultaneously with the relocated wiring.

By means of this configuration, an inductor 40 can be formed simply and at low cost without entailing an extreme increase in the number of processes, and without requiring dies or other special facilities.

Compared with a spiral-shaped inductor, in the case of a toroidal inductor leakage currents due to interference of magnetic flux with the semiconductor chip do not tend to occur, and a high Q value can be secured.

### Second Embodiment

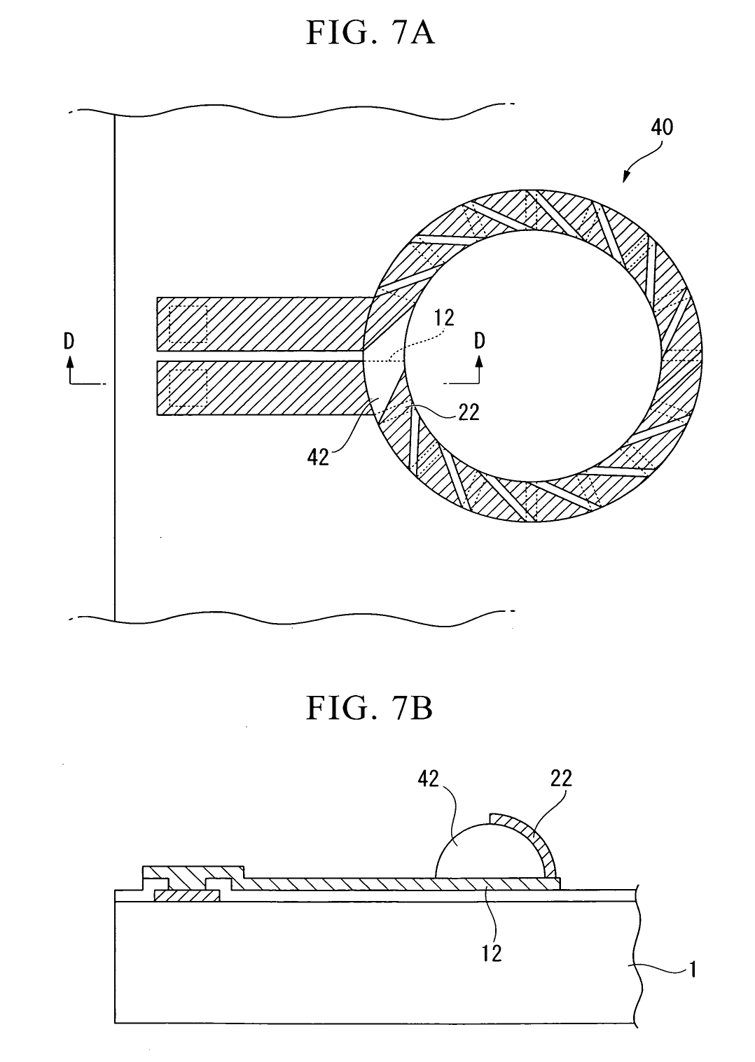

FIG. 7A is a plan view of the semiconductor chip of a second embodiment, and FIG. 7B is a cross-sectional view of the semiconductor chip taken along the line D-D in FIG. 7A.

The second embodiment differs from the first embodiment in which the core is formed using the stress-relieving layer 30, in that-the core 42 is formed independently of the stress-relieving layer 30.

Explanations of portions which are configured similarly to the first embodiment are omitted.

As shown in FIG. 7A, in the second embodiment also the first conductive elements 12 are patterned into a substantially trapezoidal shape, and a plurality of first conductive elements 12 are arranged in a radial shape in a circle.

A core 42 containing a thermoplastic resin material or the like, is formed so as to cover the center portions of the first conductive elements 12.

This core 42 has the shape of a donut which has been split in half in a direction perpendicular to the center axis as shown in FIG. 7B, the cross-sectional shape of the core 42 is substantially semicircular.

As the specific method of formation, a method can be adopted in which first a thermoplastic resin material is applied to the semiconductor chip 1, after which a transfer die is pressed onto the material while heating to mold the core 42.

As shown in FIG. 7B, the second conductive elements 22 is formed on the surface of the core 42.

As shown in FIG. 7A, the second conductive elements 22 are patterned such that, among the adjacent first conductive elements 12, the inner-side end portion of one first conductive elements element 12 is connected to the outer-side end portion of the other first conductive elements element 12.

In this way, the first conductive elements 12 and the second conductive elements 22 are connected in succession, so that the helical conductive member are formed on the periphery of the core 42, and a toroidal inductor 40 is formed.

An amorphous metal, metallic glass, or other material with high magnetic permeability may be dispersed within the resin material of the core 42.

In the second embodiment, a core 42 is provided independently of the stress-relieving layer, so that a material with high magnetic permeability can be dispersed only in the resin material forming the core 42.

By this means, the magnetic flux density in the core 42 can be increased, and the L value (inductance) and Q value of the toroidal inductor 40 can be improved.

A sputtering process, plating process, or other process may for example be used to provide the material forming the core 42 of high-permeability material, such as of permalloy alloy, amorphous metal, metallic glass, or similar, and this may be used as the core 42 of the toroidal inductor 40.

By this means, the L value (inductance) and Q value of the toroidal inductor 40 can be markedly improved.

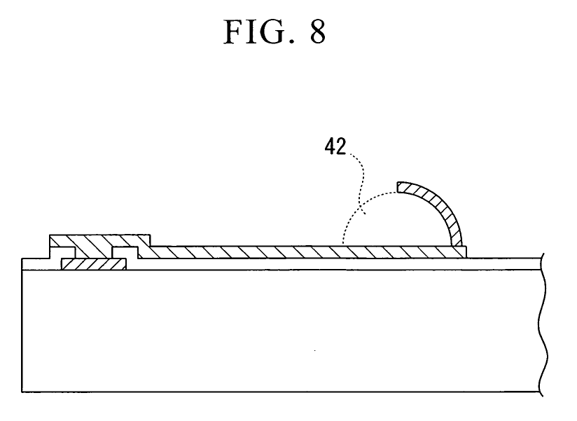

FIG. 8 explains a modified example of the second embodiment.

In this modified example, all of a core 42 or a portion of a core 42 which has once been formed is removed, and a space is formed in all of or a portion of the inside of the helical conductive member.

It is preferable that this space be formed extending over the entire circumference of the core 42.

As the method used to remove the core 42, a method of immersing the semiconductor chip in solvent to dissolve the core 42, and a method of isotropic dry etching of the core 42 by O₂ plasma, can be employed.

By means of this configuration, disordering of magnetic flux lines in the core 42 can be reduced, the magnetic permeability can be improved, and the L value (inductance) and Q value of the toroidal inductor can be improved.

Electronic Apparatus

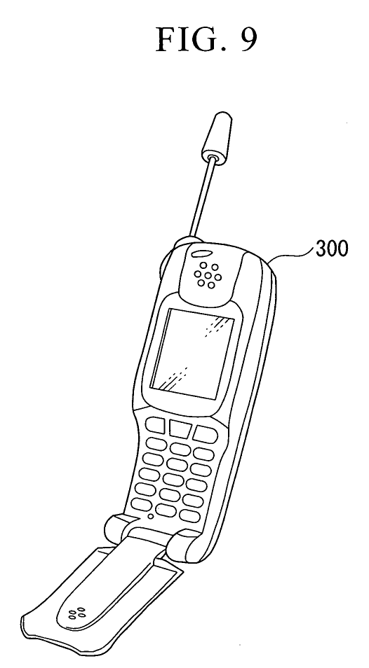

Next, reference is made to FIG. 9 to explain an example of electronic apparatus containing a semiconductor chip (electronic substrate) described above.

FIG. 9 is a perspective view of a portable telephone set.

A semiconductor chip such as described above is placed within the housing of the portable telephone set 300.

The above-described semiconductor device can be applied to various types of electronic apparatus other than portable telephone sets.

For example, application is possible to such electronic apparatus as liquid crystal projectors, personal computers (PCs) and engineering workstations (EWS) with multimedia functions, pagers, word processors, television sets, camcorders with viewfinders or direction-view monitors, electronic organizers, electronic desktop calculators, car navigation devices, POS terminals, devices provided with touchscreens, and the like.

The technical scope of this invention is not limited to the above-described embodiments, but includes inventions with various modifications made to the above-described embodiments, insofar as there is no deviation from the gist of the invention.

That is, the specific materials, layer configurations and similar described in the embodiments are merely examples, and appropriate modifications are possible.

For example, in each of the above embodiments toroidal inductors were formed on the surface of the semiconductor chip, but a toroidal inductor can be formed on the rear surface of the semiconductor chip, and electrical continuity with the surface secured by penetrating electrodes.

Moreover, in each of the above embodiments a toroidal inductor is formed on a semiconductor chip on which an electronic circuit is formed, but a toroidal inductor may be formed on an electronic substrate containing an insulating material.

Furthermore, in each of the above embodiments, a toroidal inductor is formed in which the helical conductive member is placed about the peripheral of a ring-shaped core, but an inductor may be formed in which the helical conductive member are placed about the periphery of a rod-shaped core.

However, the magnetic flux in a toroidal inductor having a ring-shaped core forms a closed loop, and so the efficiency is improved compared with an inductor having a rod-shaped core.

In each of the above embodiments, the first conductive elements and the second conductive elements are formed by an electro plating method, but a sputtering method, a vacuum deposition method, or another film deposition method may be used.

What is claimed is:

1. A manufacturing method for an electronic substrate, comprising:
preparing a substrate having an electronic circuit including connection terminals;
forming a core on the substrate and forming a helical conductive member on the core, thereby forming an inductor including the ring-shaped core and the helical conductive member; and
using at least a portion of the helical conductive member as a relocated wiring and connecting the relocated wiring to the connection terminals of the electronic circuit.

2. The manufacturing method for an electronic substrate according to claim 1, wherein the forming of the core includes forming a stress-relieving layer on the substrate.

3. The manufacturing method for an electronic substrate according to claim 2, wherein the forming of the core includes forming a high magnetic permeability member having a magnetic permeability higher than that of the stress-relieving layer in at least a portion of the core placed inside the helical conductive member.

4. The manufacturing method for an electronic substrate according to claim 1, wherein the forming of the inductor includes:
forming first conductive elements constituting at least a potion of the helical conductive member on the substrate;
forming a stress-relieving layer so as to cover the first conductive elements;
forming the core by forming penetrating holes in the stress-relieving layer so as to expose end portions of the first conductive elements; and
forming second conductive elements constituting at least a portion of the helical conductive member, and extending from the end portions of the first conductive elements to a surface of the core via the penetrating holes.

5. The manufacturing method for an electronic substrate according to claim 1, further comprising:
removing at least a portion of the core placed inside the helical conductive member.

6. The manufacturing method for an electronic substrate according to claim 4, further comprising:
forming a high magnetic permeability member having a magnetic permeability higher than that of the stress-relieving layer in at least a portion of the core placed inside the helical conductive member.

7. The manufacturing method for an electronic substrate according to claim 1, further comprising:
trimming a portion of the helical conductive member, thereby adjusting characteristics of the inductor.

8. An electronic substrate manufactured by the manufacturing method for an electronic substrate according to claim 1.

9. An electronic apparatus comprising:
the electronic substrate according to claim 8.

10. An electronic substrate, comprising:
a substrate provided with an electronic circuit including connection terminals;
an inductor including a ring-shaped core formed on the substrate and a helical conductive member formed outside the core; and
a relocated wiring constituting at least a portion of the helical conductive member, made of the same material as that of the helical conductive member, and connected to the connection terminals of the electronic circuit.

11. The electronic substrate according to claim 10 further comprising:
a stress-relieving layer made of the same material as that of the core, and formed on the substrate.

12. The electronic substrate according to claim 10, further comprising:
a stress-relieving layer formed on the substrate, including the core, covering at least a portion of the helical conductive member, and having penetrating holes formed in the stress-relieving layer and exposing end portions of at least a portion of the helical conductive member formed outside the core;
wherein the inductor includes:
first conductive elements constituting at least a potion of the helical conductive member, and formed on the substrate; and
second conductive elements constituting at least a potion of the helical conductive member, and extending from the end portions of the first conductive elements to a surface of the core via the penetrating holes.

13. The electronic substrate according to claim 12, wherein the spaces between the first conductive elements or the spaces between the second conductive elements are formed with substantially a constant width.

14. The electronic substrate according to claim 10, wherein a space is formed inside at least a portion of the helical conductive member.

15. The electronic substrate according to claim 10, wherein the core includes amorphous metal or metallic glass.

16. The electronic substrate according to claim 10, further comprising:
a conductive layer formed between the electronic circuit and the inductor.

17. An electronic apparatus comprising:
the electronic substrate according to claim 10.
